(19) United States
(12) Patent Application Publication
(10) Pub. No.: US 2014/0013312 A1
(43) Pub. Date: Jan. 9, 2014

(54) SOURCE LEVEL DEBUGGING APPARATUS AND METHOD FOR A RECONFIGURABLE PROCESSOR

(71) Applicant: Samsung Electronics Co., Ltd., Suwon-si (KR)

(72) Inventors: Young-Chul CHO, Yongin-si (KR); Jin-Sae JUNG, Yongin-si (KR)

(21) Appl. No.: 13/935,634

(22) Filed: Jul. 5, 2013

(30) Foreign Application Priority Data
Jul. 4, 2012 (KR) 10-2012-0073012

(51) Int. Cl. G06F 11/36

(52) U.S. Cl. CPC G06F 11/3636
USPC 717/129

(57) ABSTRACT

Provided are a source level debugging apparatus and method for a coarse grained array (CGA)-based reconfigurable processor. The source level debugging apparatus may determine valid operations for setting a breakpoint in a result of source code scheduling using invalid operation information, and may set the breakpoint at an address corresponding to the determined valid operations.

### CROSS-REFERENCE TO RELATED APPLICATION

This application claims the benefit under 35 USC §119(a) of a Korean Patent Application No. 10-2012-0073012, filed on Jul. 4, 2012, in the Korean Intellectual Property Office, the entire disclosure of which is incorporated herein by reference for all purposes.

### BACKGROUND

1. Field

The following description relates to a source level debugging apparatus and method for a coarse grained array (CGA)-based processor.

2. Description of the Related Art

A coarse grained array (CGA)-based reconfigurable processor has a significantly complex structure that typically includes a plurality of function units, a global resister file, local register files, and the like. In a CGA processor, function units for processing instructions are formed in an array structure. In this example, the CGA processor may configure repetitive data processing instructions of software code, which are implemented as a loop, into a software pipeline. Further, the CGA processor may parallelize and map the configured processing instructions on the array, and process the mapped processing instructions at a high speed.

In the CGA processor, a kernel may be subjected to modulo scheduling in order to improve efficiencies of the function units and reduce a size of the configuration. The kernel that is subjected to modulo scheduling may be re-used in a prologue and an epilogue of the source code. That is, a prologue, a body, and an epilogue of the loop may use the same configuration, and therefore invalid operations that do not adversely affect computation results may be performed in the prologue and the epilogue.

However, it is difficult to perform source level debugging in a CGA due to invalid operations of the prologue or the epilogue. Furthermore, breakpoints cannot be set only with respect to valid instructions.

### SUMMARY

In an aspect, there is provided a source level debugging apparatus in a reconfigurable processor, the source level debugging apparatus including a valid operation determiner that is configured to determine valid operations within code that is scheduled for processing, and a breakpoint setter that is configured to set breakpoints at addresses corresponding to the determined valid operations.

The reconfigurable processor may comprise a coarse grained array (CGA)-based processor.

The scheduled code may be a result of loop-unrolling-based modulo scheduling performed by a compiler.

The valid operation determiner may also determine an invalid operation that comprises an operation that is mapped to a prologue or an epilogue of the scheduled code in accordance with the loop-unrolling-based modulo scheduling.

The valid operation determiner may determine the valid operations based on invalid operation information.

The invalid operation information may comprise a cycle number at which an invalid operation is present, and identification (ID) information of a function unit to which the invalid operation is mapped.

In an aspect, there is provided a source level debugging method in a reconfigurable processor, the source level debugging method including determining valid operations within code that is scheduled for processing, and setting breakpoints at addresses corresponding to the determined valid operations.

The reconfigurable processor may comprise a CGA-based processor.

The scheduled code may be a result of loop-unrolling-based modulo scheduling performed by a compiler.

An invalid operation may also be determined, and the invalid operation may comprise an operation that is mapped to a prologue or an epilogue of the scheduled code in accordance with the loop-unrolling-based modulo scheduling.

The valid operations may be determined based on invalid operation information.

The invalid operation information may comprise a cycle number at which an invalid operation is present, and ID information of a function unit to which the invalid operation is mapped.

In an aspect, there is provided a method for scheduling breakpoints, the method including identifying whether an operation that is scheduled to be processed is a valid operation or an invalid operation, setting break points at addresses corresponding to valid operations, and processing, by the processor, the mapped source code.

The invalid operations may be included in at least one of a prologue and an epilogue of the mapped source code.

The invalid operations may be included in both a prologue and an epilogue of the mapped source code.

The invalid operations and the valid operations may be identified based on invalidity information, and the invalidity information may comprise operations mapped to cycle numbers and functional units of the processor, and an indication whether the operations are valid or invalid.

During processing, the processor may stop the execution of the source code at the breakpoints and transfers control to a debugging apparatus.

Other features and aspects may be apparent from the following detailed description, the drawings, and the claims.

### BRIEF DESCRIPTION OF THE DRAWINGS

FIG. 1 is a diagram illustrating an example of a source level debugging environment in a reconfigurable processor.

FIG. 2 is a diagram illustrating an example of a sample code that is to be scheduled in a reconfigurable processor.

FIG. 3 is a diagram illustrating an example of a result in which the sample code of FIG. 2 is scheduled in a reconfigurable processor.

FIG. 4 is a diagram illustrating an example of invalid operation information with respect to the result of the scheduling of FIG. 3.

FIG. 5 is a flowchart illustrating an example of a source level debugging method of a reconfigurable processor.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

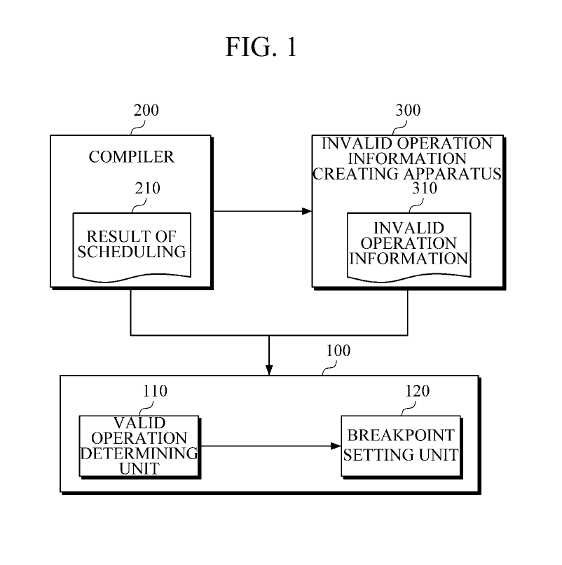

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness. FIG. 1 illustrates an example of a source level debugging environment in a reconfigurable processor.

Referring to FIG. 1, a source level debugging apparatus 100 is included in a reconfigurable processor. For example, the reconfigurable processor may be a coarse grained array (CGA)-based processor. In a CGA, when scheduling a source code implemented as a loop, a compiler 200 may schedule the source code by configuring repetitive data processing instructions as software pipelines, thereby improving processing performance. For example, the compiler 200 may generate a scheduling result 210 through loop unrolling-based module scheduling. In the CGA, efficiencies of function units may be enhanced through modulo scheduling, and a size of the configuration may be reduced. However, invalid operations are typically mapped to a prologue and an epilogue of the generated scheduling result 210.

In general, the result of an invalid operation may be nullified by using a method of guarding the invalid operations through a predicate that uses an additional hardware resource, or a method of neglecting the result of the invalid operation instead of using the result of the invalid operation. However, to nullify the result additional computations need to be performed.

In a general CGA, when breakpoints set by users at the time of source level debugging are set, a CGA program counter (PC) that is obtained by connecting an iteration number of a loop, and a CGA address within an initiation interval (II), may be used. In this case, the CGA PC can be used when performing debugging in a level of an assembler, however, it is not possible to set a breakpoint by associating the CGA PC with a line of a source program.

In addition, in the case of a processor such as Intel's Itanium, invalid operations of a prologue or an epilogue are controlled as a predicate, and a method of setting the breakpoint with respect to valid instructions in a hardware manner with reference to the value of the predicate, may be used. However, the CGA is optimized to apply a predicate only to instructions when a state of the processor has not changed, that is, when the instructions that write values in a register file or a memory are executed, and therefore the above-described method is difficult to be applied.

According to various aspects, described is a source level debugging apparatus 100 that performs source level debugging, and sets a breakpoint with respect to only valid instructions using invalid operation information 310 created in advance.

As shown in FIG. 1, the source level debugging apparatus 100 includes a valid operation determining unit 110 and a breakpoint setting unit 120. The valid operation determining unit 110 may determine valid operations in a result of source code scheduling using the invalid operation information 310.

For example, the invalid operation information 310 may be created by an invalid operation information creating apparatus 300. The invalid operation information creating apparatus 300 may determine invalid operations of a prologue and/or invalid operations of an epilogue that are included in a modulo scheduling result 210 of the compiler 200. For example, the invalid operations may be determined during modulo scheduling of the compiler 200 or after modulo scheduling of the compiler 200 is completed. The invalid operation information creating apparatus may create the invalid operation information 310 based on the determined result. As an example, the invalid operation information creating apparatus 300 may be one component module of the compiler 200.

The invalid operation information 310 may include, for example, cycle numbers at which the invalid operations of the prologue and/or the epilogue are present in the modulo scheduling result 210, and identification (ID) information of a function unit to which the invalid operation is mapped.

The valid operation determining unit 110 may receive inputs of the result 210 of modulo scheduling and the invalid operation information 310, and determine the invalid operations that are mapped to the prologue and/or the epilogue for each cycle in the result 210 of modulo scheduling using the invalid operation information 310. In addition, the valid operation determining unit 110 may determine the valid operations excluding the determined invalid operations as operations at which breakpoints are to be set. Here, the valid operation determining unit 110 may exclude the invalid operations. The result 210 of modulo scheduling may be stored in a memory, and the valid operation determining unit 110 may read the result 210 of modulo scheduling from the memory.

The breakpoint setting unit 120 may set a breakpoint at an address corresponding to the valid operations determined in the valid operation determining unit 110. For example, when a source program meets the breakpoint while being executed in a processor, the breakpoint setting unit 120 may be set in such a manner that the processor stops the execution of the source program and transfers a control to the debugging apparatus 100.

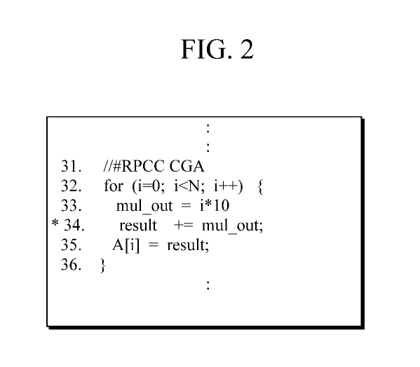

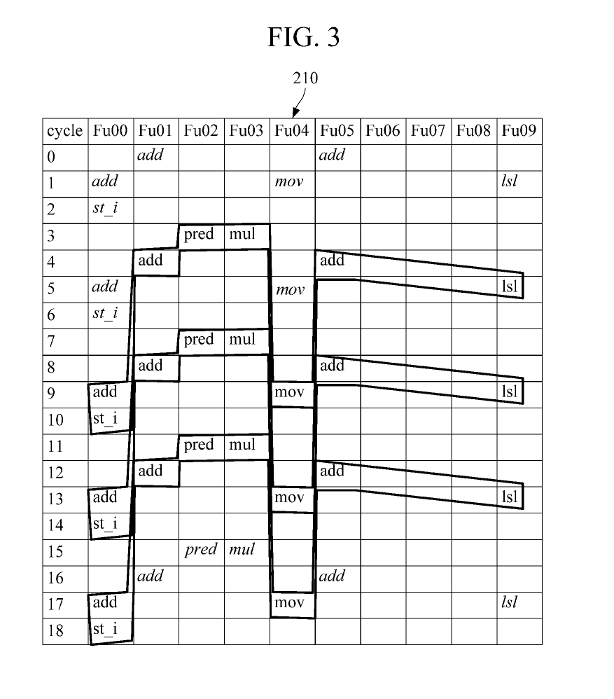

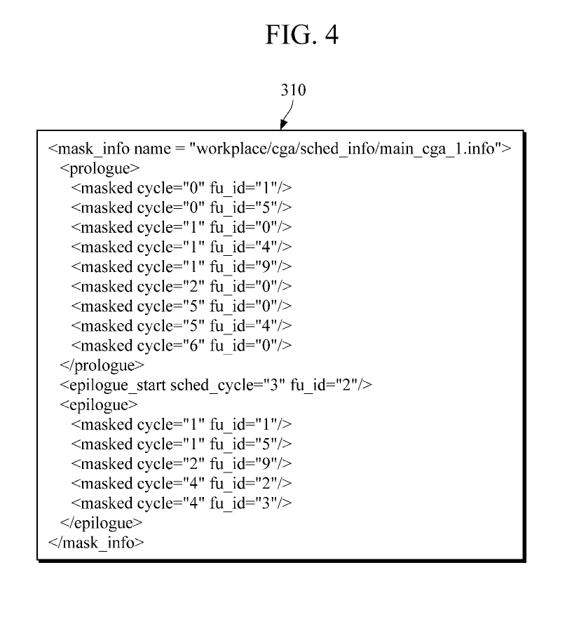

FIG. 2 illustrates an example of a sample code that is to be scheduled in a reconfigurable processor, FIG. 3 illustrates an example of a result in which the sample code of FIG. 2 is scheduled in a reconfigurable processor, and FIG. 4 illustrates an example of invalid operation information with respect to the result of the scheduling of FIG. 3.

The sample code of FIG. 2 is a source code written in a C language, and is obtained in such a manner that an integer ‘i’ is incremented by 1 from 0 to N−1. In this example, the integer ‘i’ is multiplied by 10, the multiplied results are added, and the added results are stored in the memory. The source code includes a loop in which the same instructions are repeatedly performed N times. The result 210 of loop unrolling based-modulo scheduling performed on the source code by the compiler 200, is illustrated in FIG. 3.

Referring to FIG. 3, a CGA includes 10 function units Fu00 through Fu09, and the compiler 200 maps the source code to each of the function units of the CGA processor through modulo scheduling. FIG. 3 illustrates a result of modulo scheduling performed with respect to a case in which N is 3 in the source code of FIG. 2. Here, cycles 0 to 6 indicate a prologue, cycles 7 to 14 indicate a loop body, that is, a kernel, and cycles 15 to 18 indicate an epilogue.

In the result 210 of modulo scheduling, operations indicated by italics in the prologue and the epilogue denote invalid operations. In this example, nine operations in the prologue and five operations in the epilogue are invalid operations. For convenience of description, the invalid operations are separated and shown in italics in the result 210 of modulo scheduling. However, the invalid operations and valid operations are not separately created in the actual result 210 of modulo scheduling.

In FIG. 4, an example of the invalid operation information of the prologue and the epilogue in the result 210 of modulo scheduling is illustrated. For example, the invalid operation information 310 may be created in the form of a file or table. As described herein, during modulo scheduling by the compiler 200 or after modulo scheduling by the compiler 200 is completed, the invalid operation information 310 may be created using the result 210 of modulo scheduling by the invalid operation information creating apparatus 300. As a result, the invalid operations may be masked or otherwise avoided and no breakpoints are set.

According to various aspects, the invalid operation information 310 may include cycle numbers in which invalid operations are present in the result 210 of modulo scheduling, and ID information on which the invalid operations are mapped, as shown in FIG. 4. In the example of FIG. 4, an ‘add’ operation mapped on function units 1 and 5 of a cycle 0 of the prologue, ‘add’, ‘mov’, and ‘Isl’ operations respectively mapped on function units 0, 4, and 9 of a cycle 1, a ‘st_i’ operation mapped on a function unit 0 of a cycle 2, ‘add’ and ‘mov’ operations respectively mapped on function units 0 and 4 of a cycle 5, and a ‘st_i’ operation mapped on a function unit 0 of a cycle 6, are all invalid operations.

Based on the result 210 of modulo scheduling shown in FIG. 3, when N is 3 in the source code of FIG. 2, and a user wishes to set a breakpoint at a source code line 34 of FIG. 2, the ‘add’ operation corresponding to the addition operation of the source code line 34 is mapped to function unit Fu 00 at the cycles 1, 5, 9, 13, and 17 through the loop unrolling based-modulo scheduling so as to be repeatedly performed five times.

Accordingly, the valid operation determining unit 110 may determine the ‘add’ operations of the cycles 1 and 5 as invalid operations using the invalid operation information 310, and determine the ‘add’ operations of the cycles 9, 13, and 17 excluding the above-described ‘add’ operations from cycles 1 and 5, as valid operations. The breakpoint setting unit 120 may set a breakpoint in an address corresponding to the cycles 9, 13, and 17 as described herein.

According to various aspects, using information about invalid operations of the prologue and/or the epilogue which are created in advance, debugging of a source level may be performed, and breakpoints may be set only with respect to valid operations excluding the invalid operations. Accordingly, it is possible to significantly improve performance of source level debugging.

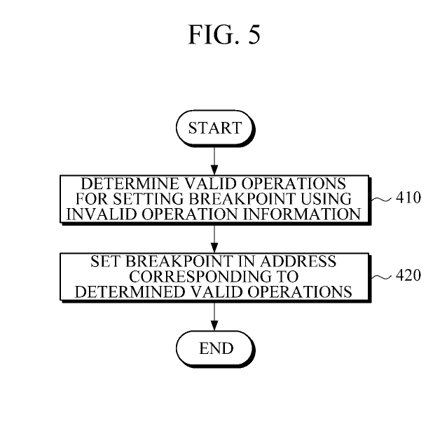

FIG. 5 illustrates an example of a source level debugging method in a reconfigurable processor.

First, in step 410, valid operations and invalid operations are determined using invalid operation information 310 of the source code scheduling result 210. Here, breakpoints may be set for the valid operations excluding the invalid operations.

For example, the invalid operation information 310 may include cycle numbers in which invalid operations included in the prologue and epilogue are present in the modulo scheduling result 210 of the compiler 200, and ID information of function units on which the invalid operations are mapped. The source level debugging apparatus 100 may receive inputs of the result 210 of scheduling and the invalid operation information 310.

The invalid operations mapped to the prologue and/or the epilogue may be determined for each cycle using the input invalid operation information 310 of the modulo scheduling result 210. Here, valid operations excluding the determined invalid operations among operations may be determined. Accordingly, a breakpoint may be set at addresses corresponding to the determined valid operations, and no breakpoint is set at addresses corresponding to invalid operations.

According to various aspects, as described in the examples of FIGS. 2 to 4, when a user wishes to set a breakpoint in the source code line 34 of FIG. 2, the source level debugging apparatus 100 may determine, as invalid operations, ‘add’ operations of the cycles 1 and 5 mapped to the function unit Fu 00, and determine, as valid operations, ‘add’ operations of the cycles 9, 13, and 17 mapped to the function unit Fu00.

At 420, a breakpoint is set at an address corresponding to the determined valid operations. For example, the source level debugging apparatus 100 may set the breakpoint at the addresses of the cycles 9, 13, and 17, thereby setting the breakpoint only with respect to the valid operations.

According to various aspects, a source level debugging apparatus and method in a reconfigurable CGA-based processor are described. The apparatus and method enable source level debugging by setting a breakpoint with respect to only valid operations excluding invalid operations which are mapped on a prologue or an epilogue in accordance with loop unrolling based-modulo scheduling.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable storage mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A source level debugging apparatus in a reconfigurable processor, the source level debugging apparatus comprising:
a valid operation determiner that is configured to determine valid operations within code that is scheduled for processing; and
a breakpoint setter that is configured to set breakpoints at addresses corresponding to the determined valid operations.

2. The source level debugging apparatus of claim 1, wherein the reconfigurable processor comprises a coarse grained array (CGA)-based processor.

3. The source level debugging apparatus of claim 1, wherein the scheduled code is a result of loop-unrolling-based modulo scheduling performed by a compiler.

4. The source level debugging apparatus of claim 3, wherein the valid operation determiner also determines an invalid operation that comprises an operation that is mapped to a prologue or an epilogue of the scheduled code in accordance with the loop-unrolling-based modulo scheduling.

5. The source level debugging apparatus of claim 1, wherein the valid operation determiner determines the valid operations based on invalid operation information.

6. The source level debugging apparatus of claim 5, wherein the invalid operation information comprises a cycle number at which an invalid operation is present, and identification (ID) information of a function unit to which the invalid operation is mapped.

7. A source level debugging method in a reconfigurable processor, the source level debugging method comprising:
determining valid operations within code that is scheduled for processing; and
setting breakpoints at addresses corresponding to the determined valid operations.

8. The source level debugging method of claim 7, wherein the reconfigurable processor comprises a CGA-based processor.

9. The source level debugging method of claim 7, wherein the scheduled code is a result of loop-unrolling-based modulo scheduling performed by a compiler.

10. The source level debugging method of claim 9, wherein an invalid operation is also determined, and the invalid operation comprises an operation that is mapped to a prologue or an epilogue of the scheduled code in accordance with the loop-unrolling-based modulo scheduling.

11. The source level debugging method of claim 7, wherein the valid operations are determined based on invalid operation information.

12. The source level debugging method of claim 11, wherein the invalid operation information comprises a cycle number at which an invalid operation is present, and ID information of a function unit to which the invalid operation is mapped.

13. A method for scheduling breakpoints, the method comprising:
identifying whether an operation that is scheduled to be processed is a valid operation or an invalid operation;
setting break points at addresses corresponding to valid operations; and
processing, by the processor, the mapped source code.

14. The method of claim 13, wherein the invalid operations are included in at least one of a prologue and an epilogue of the mapped source code.

15. The method of claim 13, wherein the invalid operations are included in both a prologue and an epilogue of the mapped source code.

16. The method of claim 13, wherein the invalid operations and the valid operations are identified based on invalidity information, and
the invalidity information comprises operations mapped to cycle numbers and functional units of the processor, and an indication whether the operations are valid or invalid.

17. The method of claim 13, wherein during processing, the processor stops the execution of the source code at the breakpoints and transfers control to a debugging apparatus.
